(19) United States
(12) Patent Application Publication
(10) Pub. No.: US 2009/0147678 A1
(43) Pub. Date: Jun. 11, 2009

(54) SYSTEMS AND METHODS FOR TRAFFIC FLOW BASED RATE ADAPTATION IN PACKET-BASED NETWORKS

(75) Inventors: Ariton E. XHAFA, Plano, TX (US); Xiaolin LU, Plano, TX (US); Henry S. EILTS, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/276,216

(22) Filed: Nov. 21, 2008

Related U.S. Application Data
(60) Provisional application No. 60/992,422, filed on Dec. 5, 2007.
(60) Provisional application No. 61/022,858, filed on Jan. 23, 2008.

(51) Int. Cl. G08C 15/00

(52) U.S. Cl. 370/232

(57) ABSTRACT

Embodiments provide systems and methods for traffic flow based rate adaptation in packet-based networks. In some embodiments, a communications system comprises at least one receiver and a transmitter able to control transmission to the at least one receiver of a packet among a plurality of traffic flows, each traffic flow having its own transmission rate adaptation mechanism. In other embodiments, a communications method comprises determining, by a transmitter able to control transmission of a packet among a plurality of traffic flows each having its own transmission rate adaptation mechanism, a parameter value, and, depending upon the parameter value, adapting the transmission rate of at least one traffic flow. In further embodiments, a communications device comprises a transmitter able to control transmission of a packet among a plurality of traffic flows, each traffic flow having its own transmission rate adaptation mechanism.

### CROSS-REFERENCE TO RELATED APPLICATION(S)

The present application claims priority to U.S. provisional patent application Ser. No. 60/992,422, filed Dec. 5, 2007, and entitled “Hybrid Approach to Solving Coexistence Problem in Wireless Networks” and U.S. provisional patent application Ser. No. 61/022,858, filed Jan. 23, 2008, and entitled “Traffic Flow Based Rate Adaptation in Packet Based Networks”, both hereby incorporated in their entirety herein by reference.

### BACKGROUND

Next-generation mobile devices will be able to access a variety of network technologies including, for example, worldwide interoperability for microwave access (WiMAX) networks, wireless local area network (WLAN) networks, long term evolution (LTE) mobile telephony networks, personal area networks (PANs), wireless universal serial bus (USB) networks or BLUETOOTH® (BT) technology networks, etc. It should be understood, and as illustrated in FIG. 1, wireless local area network (“WLAN”; 2.4-2.5 GHz) and other technologies, such as Bluetooth (“BT”; 2.4-2.4835 GHz) and Worldwide Interoperability for Microwave Access (“WiMAX”; 2.3-2.4 GHz and 2.5-2.7 GHz), operate at relatively close and, in some cases, overlapping frequency bands with respect to each other. The various technologies have different transmission timing requirements in order to provide a needed quality of service (QoS). Quality of service refers to mechanisms for controlling resource reservation rather than the achieved service quality. QoS is the ability to provide different priority to different applications, users, or data flows, or to guarantee a certain level of performance to a data flow, e.g., guarantee a required bit rate, delay, jitter, packet dropping probably, bit error rate, etc.

Quality of service guarantees are important, for example, if the network capacity is insufficient or limited, especially for real-time streaming multimedia applications such as voice over IP, online games and IP-TV, since these delay sensitive applications often require fixed bit rate. The IEEE802.11 specification provides a quality of service control protocol that enables a service differentiation to be provided for packets. For example, voice and e-mail traffic require different quality of service levels to provide acceptable service quality. In particular, voice packets need to be delivered within strict delay bounds whereas e-mail packets are more delay tolerant.

In wireless communications, many techniques have been devised to make the communications more reliable. One such technique is link adaptation. For example, link adaptation works in 802.11a/g networks as follows. If the transmission of a packet from transmitting node A to receiving node B is not successful, then node A reduces its transmission rate to increase the chances that the packet is successfully received at node B. In wireless local area networks (WLANs), such reduction in transmission rate is called rate fallback. Alternatively, if the transmission of a packet from transmitting node A to receiving node B is successful, then node A may increase its transmission rate in an effort to increase throughput. Rate adaptation (i.e., reducing or increasing the transmission rate) may be confined to a given number of unsuccessful/successful packet transmissions, respectively, between specific devices, e.g., nodes A and B.

While such rate adaptation mechanisms have been shown to perform reasonably well, such mechanisms have drawbacks that are inconvenient. As a result, various solutions are needed to enable the competition for resources among the technologies onboard a single device to be less inconvenient to users.

### BRIEF DESCRIPTION OF THE DRAWINGS

For a detailed description of exemplary embodiments of the invention, reference will be made to the accompanying drawings in which:

FIG. 1 illustrates an example of overlapping communications networks in which embodiments may be employed to advantage;

FIG. 2 illustrates an example wireless local area network (WLAN) with an access point and a plurality of wireless devices/stations, according to embodiments;

FIG. 3 illustrates an exemplary access point and/or wireless device, according to embodiments;

FIG. 4 illustrates an exemplary device, according to embodiments;

FIG. 5 illustrates an example rate adjustment mechanism, according to embodiments;

FIG. 6 illustrates an exemplary method of determining per flow rate adjustment, according to embodiments; and

FIG. 7 illustrates another exemplary method of determining per flow rate adjustment, according to embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

While rate adaptation mechanisms such as mentioned above have been shown to perform reasonably well, such mechanisms fail to adapt the transmission rates based on the packet size. It is possible to adopt sophisticated approaches that relate channel measurements and/or signal-to-noise ratio (SNR) to the packet sizes and create a lookup table from the relationships. Then, every time a packet of a particular size is selected, the corresponding best transmission rate is also selected. While this approach is attractive, it unfortunately adds significant and unnecessary complexity to a device's architecture. Furthermore, devices that run on 802.11g technology which also implement 802.11e technology will require undesirably drastic and complex changes in their architectures to support enhanced link adaptation schemes.

Existing communication systems do not distinguish among traffic flows to a device. Thus, it should be appreciated that the rate adaptation discussed above—in which all traffic flows, regardless of network technology, are subjected to the same transmission rate—results in a number of unfortunate side effects. Examples of network technologies that may be represented by subsystems aboard a transmitting device include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc.

To better understand one of the undesirable side effects, it should be appreciated that packet reception failures may occur for a number of reasons, e.g., because of collision (resulting in avalanche effect), because of channel errors, etc. Because a transmitter does not necessarily know why a packet reception failure occurred, an existing transmitter decreases the transmission rate in an effort to increase the probability of reception success for subsequent packet transmissions based on the assumption that the failure was most probably a result of deteriorating channel conditions. Thus, while making an effort to increase the probability of reception success is laudable, because a reception failure causes an existing transmitter to apply rate adaptation to all of its traffic flows to a particular device, then the AP's or transmitter's network suffers as a whole. It should also be understood that in some embodiments and discussion herein transmitters may also be referred to as an access point (AP); similarly, in some embodiments and discussion herein receivers may also be referred to as a STA.

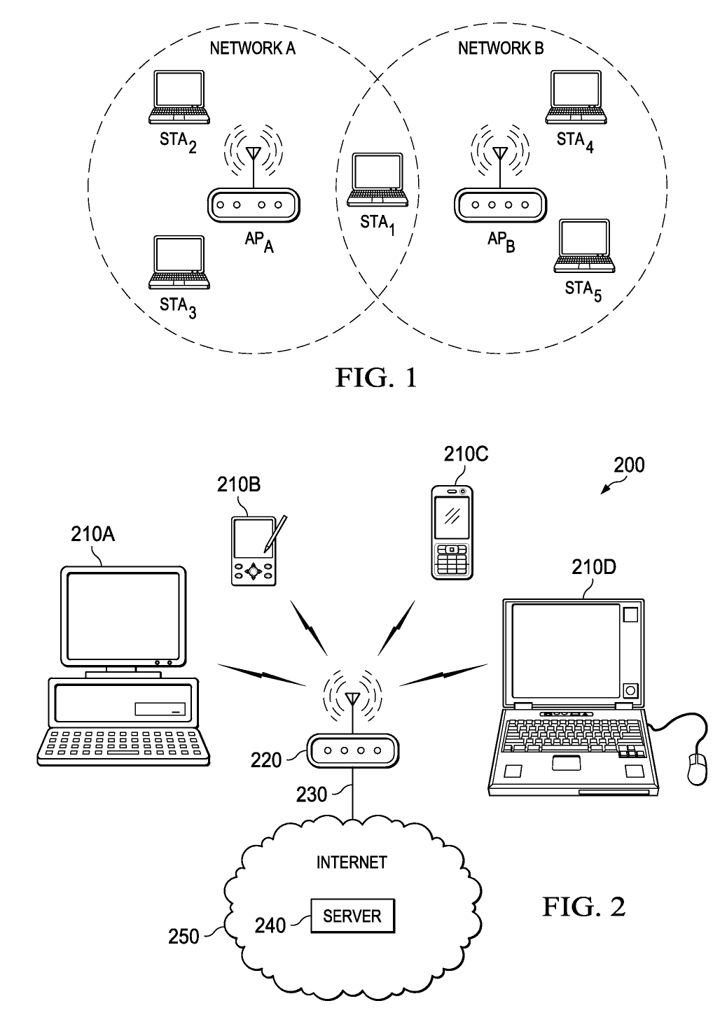

Understandably, if the packet reception failure is caused due to channel errors, such poor channel quality may trigger packet reception failures with other devices/STAs in the AP's transmission network. However, if the packet transmission failure is caused by collision—a common cause of packet reception failure—such failure triggers the transmitter's rate fallback mechanism for packets sent to the receiving device. The triggering of the fallback mechanism in turn causes the transmission rate(s) on all of the traffic flows from that transmitter to the receiving device to be reduced—simply because the intended receiving STA is also “hearing” traffic from a nearby STA in a neighboring network outside of the transmitter's transmission network. An example of this latter scenario is illustrated in FIG. 1. As can be seen, Network A comprises a transmitter—in this example AP_{A}—and three receivers, STA₁, STA₂ and STA₃, while Network B comprises a transmitter—in this example AP_{B}—and three receivers, STA₁, STA₄ and STA₅. In this example, assume each of Networks A and B consist of devices that communicate among WLAN, Bluetooth and/or WiMAX technologies, and that STA₁ is using WLAN on Network A, and alternatively communicating on Network B for WiMAX transmissions. It should be readily understood that receiver STA₁ may instead communicate on either or both networks for more, different or fewer network technology traffic flows than identified in this scenario. In this example, STA₁ can most definitely “hear” communication activity among the devices in both networks and receive transmissions from more than one transmitter, at least because STA₁ is within the receiving radius of both transmitters, AP_{A} and AP_{B}. For example STA1 may receive overlapping transmissions from AP_{A} of Network A and STA₅ of Network B. As a result, STA₁ would “hear” both transmissions, which would potentially cause the packet received from AP_{A} (or both, AP_{A} and STA₅) to be erroneously decoded. Thus, AP_{A} would react by automatically decreasing its transmission rate when next transmitting to STA₁, regardless of traffic flow. Moreover, it is possible that AP_{A} and STA₂, for example, may both transmit at the same time; AP_{A} to STA₁ and STA₂ to AP_{A}. As a result, STA₁ would “hear” both transmissions, which would potentially cause the packet received from AP_{A} (or STA₂, or both) to be erroneously decoded. Thus, AP_{A} and/or STA₂ would react by automatically decreasing their transmission rates when next transmitting to STA₁ and AP_{A}, respectively, regardless of traffic flow. Of course, it should be appreciated that FIG. 1 is strictly for illustration; there may be more or fewer receivers in either or both networks, and certainly there are likely to be more networks than the two networks illustrated for the sake of simplicity. It should be further appreciated that at least one transmitter and/or receiver within a network may have more than one traffic flow per device—some with larger packet sizes due to the nature of the particular traffic flow or quality of service (QoS) requirements; others with smaller packet sizes (again, due to the nature of the particular traffic flow/QoS requirements). Each traffic flow is a function of, and QoS requirements for that traffic flow states, a specific packet size and packet error rate (PER) requirements for the particular network technology traffic flow. As is known, packet error rate (PER) is the ratio, in percent, of the number of packets sent by the transmitter but not successfully received by a receiver to the number of packets sent to that receiver by the transmitter.

Embodiments of the present invention may be employed in communication networks, including as illustrated in FIG. 1, to reduce the effect of STA₁ failing to receive a packet transmitted from AP_{A} because, for example, STA₁ was operating in Network B; i.e., exchanging information with AP_{B}. Without embodiments of the present invention, AP_{A} will reduce its transmission rate to STA₁—for all traffic flows being transmitted from AP_{A}, including other network technologies onboard STA₁ which are not affected or reachable by Network B.

Regardless, by employing embodiments to manage/track each traffic flow with each receiver in a network, a transmitter can adjust its transmission rate (for subsequent transmissions regardless of success or failure) on a traffic flow basis, thereby not making all the traffic flows destined to a particular device/STA in the transmitter's transmission network suffer because of the failure(s) of one flow to this device/STA.

Thus, in light of the foregoing, embodiments of the invention provide communication systems and methods for rate adaptation on a per traffic flow basis. Since data packet size is directly proportional to the transmission rate, changing the transmission rate affects the packet size in a traffic flow, and in turn the network throughput. Thus, instead of applying the rate adaptation to all of the packets transmitted from, for example, an access point (AP) or device/station (STA), embodiments provide each traffic flow its own rate adaptation mechanism or process. At least one resulting advantage: implementing rate adaptation on a per traffic flow basis improves the performance of the overall network.

FIG. 2 illustrates an example wireless local area network (WLAN) 200 with a plurality of wireless devices/stations—referred to individually herein as device, station, STA or device/station—and an access point (AP), according to embodiments. It should be appreciated that the network of FIG. 2 is meant to be illustrative and not meant to be exhaustive; for example, it should be appreciated that more, different or fewer communication systems, devices and/or paths may be used to implement embodiments. To provide wireless data and/or communication services (e.g., telephone services, Internet services, data services, messaging services, instant messaging services, electronic mail (email) services, chat services, video services, audio services, gaming services, etc.), the exemplary WLAN 200 comprises access point (AP) 220 and any of a variety of fixed-location and/or mobile wireless devices or stations (STAs), four of which are respectively designated in FIG. 2 with reference numerals 210A, 210B, 210C and 210D. Exemplary devices 210 include any variety of personal computer (PC) 210A with wireless communication capabilities, a personal digital assistant (PDA) 210B, an MP3 player, a wireless telephone 210C (e.g., a cellular phone, a Voice over Internet Protocol (VoIP) telephonic functionality, a smart phone, etc.), and a laptop computer 210D with wireless communication capabilities, etc. At least one of AP 220 and STAs 210A-D are preferably implemented in accordance with at least one wired and/or wireless communication standard (e.g., from the IEEE 802.11 family of standards). Further, at least one device 210 may comprise a plurality of co-existing wireless network technology subsystems onboard. In at least some embodiments, device 210 consists of a WLAN network and a BT network. The WLAN network may handle File Transfer Protocol (FTP), with internet file download, and e-mail traffic, while the BT network may handle synchronous connection-oriented high-quality voice level 3 (SCO HV3) traffic. STA is a WLAN and BT node and transmissions in different networks are preferably achieved via a time-duplexing approach (ON/OFF). It will be noted that reference to “STA” (station) may be used herein as a shorthand reference to “STA1”, “device 210” and “device 410” during respective discussions to aid in ease of understanding.

In the example of FIG. 2, to enable the plurality of devices/STAs 210A-D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver, for example, any variety of data, video, audio, telephone, gaming, Internet, messaging, electronic mail, etc. service. Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s).

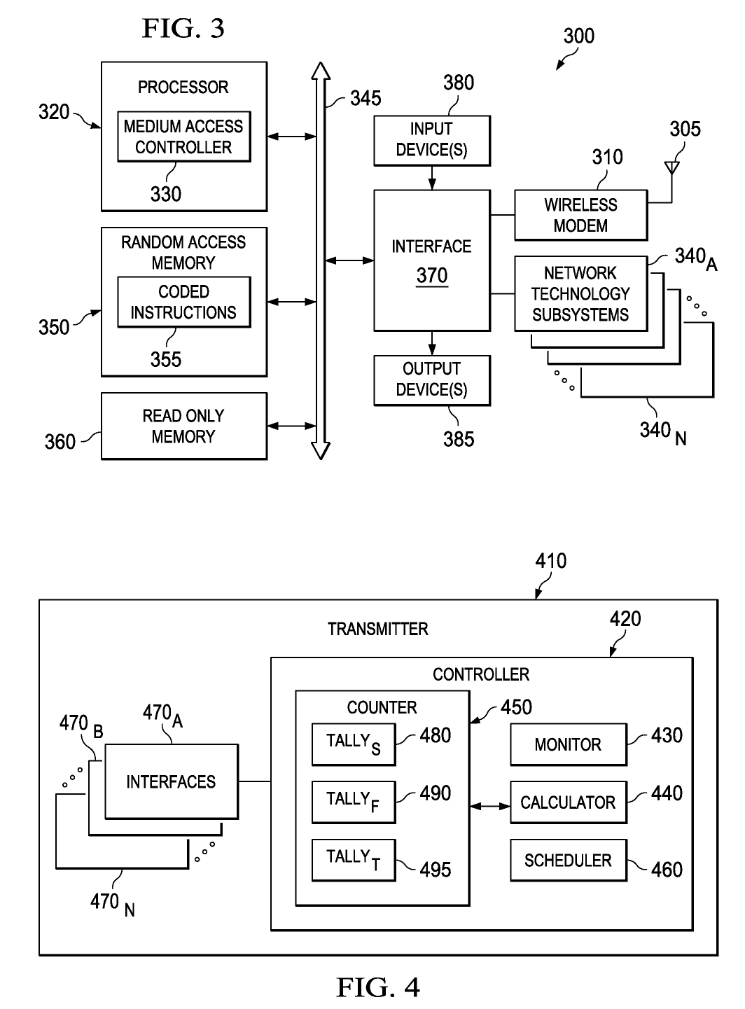

The systems and methods described herein may be implemented on any general-purpose computer with sufficient processing power, memory resources, and network throughput capability to handle the necessary workload placed upon it. FIG. 3 illustrates an exemplary, general-purpose computer system suitable for implementing at least one embodiment of a system to transmit and respond to signals as disclosed herein. Illustrated exemplary device 300 which may be an access point and/or wireless device, according to embodiments. It should be expressly understood that device 300 may be a transmitter, a receiver, or both. It should further be expressly understood that any device on, for example, WLAN 200 or other embodiments, may at times be an access point and at other times be a station. It should also be understood that in some embodiments, there may be at least one dedicated access point, with any number of devices acting as stations.

Exemplary device 300 comprises at least one of any of a variety of radio frequency (RF) antennas 305 and any of a variety of wireless modems 310 that support wireless signals, wireless protocols and/or wireless communications (e.g., according to IEEE 802.11n). RF antenna 305 and wireless modem 310 are able to receive, demodulate and decode WLAN signals transmitted to and/or within a wireless network. Likewise, wireless modem 310 and RF antenna 305 are able to encode, modulate and transmit wireless signals from device 300 to and/or within a wireless network. Thus, RF antenna 305 and wireless modem 310 collectively implement the “physical layer” (PHY) for device 300. It should be appreciated that device 300 is communicatively coupled to at least one other device and/or network (e.g., a local area network (LAN), the Internet 250, etc.). It should further be understood that illustrated antenna 305 represents one or more antennas, while the illustrated wireless modem 310 represents one or more wireless modems.

The exemplary device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by DRAM, SDRAM, and/or any other type of RAM device; ROM 360 may be implemented by flash memory and/or any other type of memory device.

Processor 320 implements MAC 330 using one or more of any of a variety of software, firmware, processing thread(s) and/or subroutine(s).

MAC 330 provides medium access controller (MAC) functionality and further implements, executes and/or carries out functionality to facilitate, direct and/or cooperate in avoiding avalanche effect. MAC 330 is implemented by executing one or more of a variety of software, firmware, processing thread(s) and/or subroutine(s) with the example processor 320; further, MAC 330 may be, additionally or alternatively, implemented by hardware, software, firmware or a combination thereof, including using an application specific integrated circuit (ASIC), a programmable logic device (PLD), a field programmable logic device (FPLD), discrete logic, etc.

Device 300 also preferably comprises at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

Interface 370, additionally or alternatively, communicatively couples wireless modem 310 with processor 320 and/or MAC 330. Interface 370 enables interface to, for example and not by way of limitation, Ethernet cards, universal serial bus (USB), token ring cards, fiber distributed data interface (FDDI) cards, network interface cards, wireless local area network (WLAN) cards, etc. to enable device 300 to communicate with other devices and/or communicate via Internet 250 or at least one intranet. With such a network connection, it is contemplated that processor(s) 320 would be able to receive information from at least one type of network technology, and/or output information to at least one type of network technology in the course of performing the herein-described processes. It should be appreciated that interface 370 implements at least one of a variety of interfaces, such as an external memory interface, serial port, communication internal to device 300, general purpose input/output, etc.

Device 300 further comprises at least two dissimilar network technology subsystems 340; as a result, device 300 is said to have co-existing network technology. “Dissimilar” is used in this context to mean that at least one of the subsystems 340 is from a different network technology than another one of the subsystems 340. It should be understood that some embodiments of subsystems 340 may have their own dedicated wireless modem and antenna, while other embodiments may share either or both of a wireless modem and antenna. Embodiments of device 300 comprise at least two wireless network technology subsystems 340. FIG. 3 illustrates network technology subsystems 340_{A}-340_{N}, where N=the number network technology subsystems in device 300. As previously noted, examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc. Processor 320 interacts with network technology subsystems 340 via corresponding interfaces 470_{A}-470_{N} (see FIG. 4) implemented by interface 370. It should be appreciated that, for the ease of illustration, only two or three such network technologies may be discussed in connection with any particular embodiment, that more or fewer such technologies may be onboard a device, and that the present teachings apply equally thereto.

As illustrated in FIG. 4, an exemplary device 410 comprises a controller 420 and interfaces 470_{A}-470_{N}, where N=the number of onboard network technologies corresponding to each of the respective dedicated interfaces. Controller 420, in turn, comprises monitor 430, calculator 440, counter 450 and scheduler 460. It should be appreciated that although the example device of FIG. 4 illustrates controller 420 as comprising, monitor 430, calculator 440, counter 450 and scheduler 460, that some or several of these elements may be external to controller 420. Moreover, it should also be appreciated that, in many embodiments, controller 420 also comprises additional functionality such as security inputs (often from a user), managing power saving features for the interfaces, etc. Embodiments of device 410 consist of wireless—and, in some cases, wired—links. Because at least some of the links are wireless, some communications may interfere with each other. For example, it may not be possible for two links to be active at the same time because the transmission of one interferes with the transmission of the other. Preferably time-division multiplexing is used where interfering links operate at different times, but embodiments of scheduler 460 preferably understand the priority and parameters of each onboard network technology, as well as any negotiated parameters established during initial association with an AP or transmitter.

Controller 420 schedules the duration each active network traffic flow may keep priority on the resources of device 410. There are a variety of scheduling options, one of which may be fair allocation. Generally, the device alternates among the various active traffic flows—corresponding to each of the initiated network technology subsystems represented on device 410—depending upon each service/traffic flow's priority as determined by scheduler 460. Each network preferably takes sequential turns in using the resources of device 410 to send packets to—or otherwise communicate with—networks outside of device 410. Often, the scheduler will establish a periodic transmission time for each onboard technology network subsystem, for improved and efficient use of device 410's resources. The periodic transmission(s) may also be provided to other devices within any particular network to enable network-specific transmissions by the other device(s) during known network-specific active modes (reception) intervals.

It should be understood that there may be a variety of types of traffic flows, e.g., network control (time critical and safety critical), voice (time critical), video (time critical), controlled load (non-time-critical), excellent effort, best effort, background, etc., each type of traffic flow with its own sensitivity to time and packet loss. Network control is both time and loss critical; voice is time critical but of lower priority than network control. Controlled load is non-time-critical, but is loss sensitive. Excellent effort is non-time-critical, but loss sensitive, but of lower priority than controlled load. This is a best-effort type of service that an information services organization would deliver to its most important customers. Best effort is non-time-critical and loss insensitive; background is non-time-critical and loss insensitive, but of lower priority than best effort. Scheduler 460 preferably takes the various traffic flow sensitivities and priorities, together with the transmission rate determined by calculator 440, when directing controller 420 to transmit a packet.

Controller 420 calls monitor 430 to monitor the at least one active traffic flow; in some embodiments, monitor 430 only monitors the existence of active traffic flows onboard device 410, while in other embodiments, monitor 430 also monitors what network technology (e.g., WLAN, BT, WiMAX, etc.) and what type of transmission (e-mail, streaming video, VoIP, etc.) are affected. It should be appreciated that embodiments involve traffic flows regardless of type of traffic or whether the traffic is unicast, broadcast, multicast, etc. It should be further appreciated that the transmissions corresponding to more than one traffic flow may be, in some embodiments, simultaneously occurring.

Additionally, in at least some embodiments, controller 420 employs monitor 430 to track changes in the active traffic flows. If monitor 430 determines that there has been a change in at least one of the active traffic flows, it also identifies the change. As one example, and not by way of limitation, e.g., a traffic flow initiated, changed, ceased, etc. Embodiments of scheduler 460 dynamically focus on scheduling and prioritizing among the service calls (requests) based on the information gathered by monitor 430.

Embodiments of calculator 440 perform various calculating functions, including, but not necessarily limited to, determining transmission rate adaptations for each active traffic flow on device 410. Calculator 440 employs counter 450, as well as registers containing tally values—depending upon embodiments—to determine whether to adjust the transmission rate. In some embodiments, the transmission rate for a particular traffic flow will be decreased when the number of packet failures is greater than or equal to a predetermined failure threshold. In some embodiments, the transmission rate for a particular traffic flow will be increased when the number of packet successes is greater than or equal to a predetermined success threshold. In some embodiments, the transmission rate for a particular traffic flow will be decreased when the calculated packet error rate for the particular traffic flow is greater than or equal to a predetermined failure threshold. In some embodiments, the transmission rate for a particular traffic flow will be increased when the calculated packet error rate for the particular traffic flow is less than or equal to a predetermined success threshold. Regardless of whether the transmission rate is adapted, controller 420 is directed to transmit at the calculated transmission rate.

It should be understood that transmitter 410 may, depending upon specific embodiment, adapt the transmission rate of a particular traffic flow on the basis of any desired parameters, including for example and not by way of limitation, signal-to-noise ratio of the transmission channel, packet error rate, bit error rate, the level of power used for transmission, error control parameters such as those measured by the number of times an automatic repeat request (ARQ) is triggered, the number of packet transmission failures, the number of packet transmission successes, packet size, other communication channel parameters, etc. For clarification, while the present discussion describes some specific examples, it should be clearly understood that embodiments are not so limited.

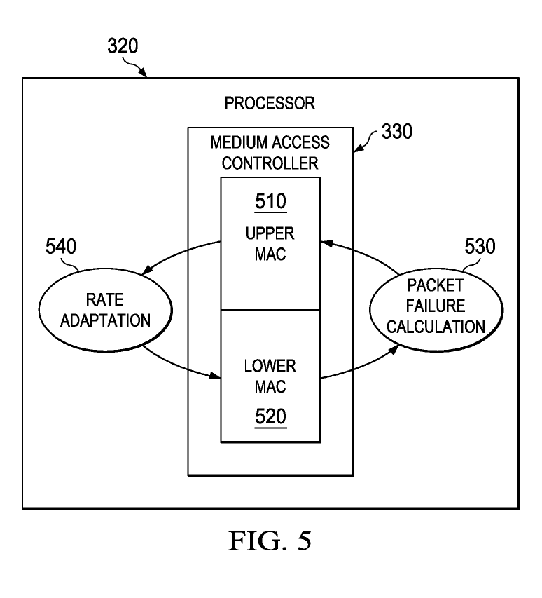

FIG. 5 illustrates an example rate adjustment mechanism, according to embodiments. Such embodiment may be used in a variety of networks, but will be discussed herein in connection with a WLAN network. As illustrated in FIG. 300, exemplary transmitting device 300 comprises processor 320 that in turn comprises medium access controller (MAC) 330. Returning to FIG. 5, controller 330 in turn comprises an upper MAC layer 510, which in at least some embodiments is implemented in firmware (FW), and a lower MAC layer 520, which in at least some embodiments is implemented in a combination of firmware and hardware (FW/HW). Processing portion 320 also comprises, in at least some embodiments, a hardware loop 530, and a firmware loop 540. Hardware loop 530, at a minimum, calculates whether there has been a packet failure at least partially based on information from lower MAC layer 520. Its calculation(s) are provided/used by upper MAC layer 510. In some embodiments, calculator 440 comprises loop 530; in other embodiments, calculator 440 accesses a remote loop 530 to accomplish its functions. Firmware loop 540, at a minimum, communicates the upper MAC layer 510's determination of whether to adapt the rate—and if so, to what specific transmission rate—to lower MAC layer 520. In some embodiments, calculator 440 comprises loop 540; in other embodiments, calculator 440 accesses a remote loop 540 to accomplish its functions.

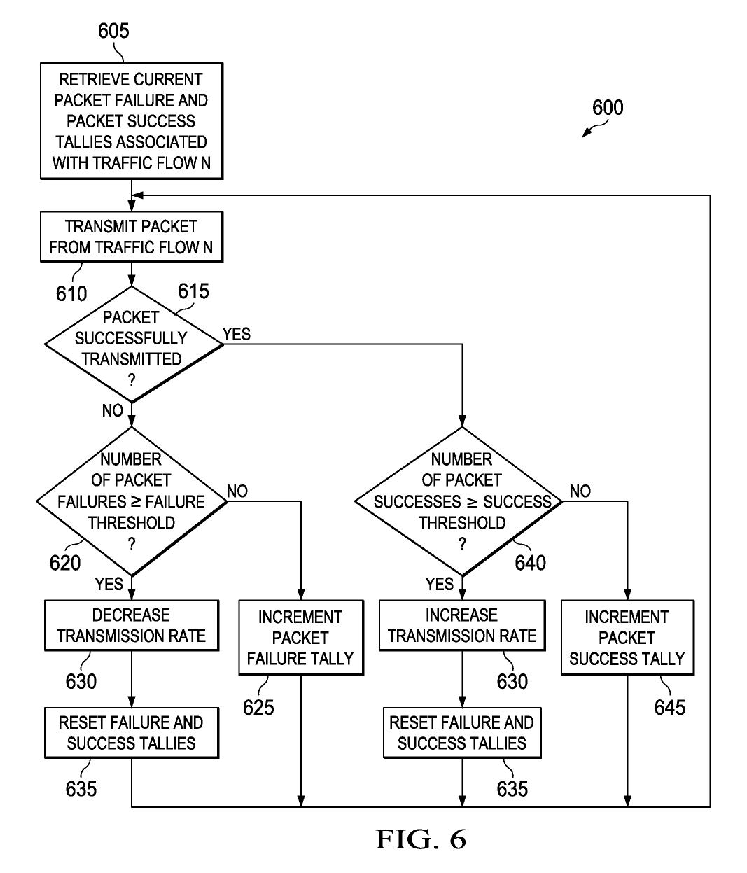

FIG. 6 illustrates an exemplary method 600 for adapting transmission rate on a per flow basis, according to embodiments. For each traffic flow N, transmitter 410 keeps track of the values of parameter(s) of interest, such as in this exemplary method, and not by way of limitation, the number of consecutive failure/successfully transmitted packets. Embodiments determine whether a transmitted packet was successfully received by whether the transmitter receives an ACK or Block ACK (acknowledgements) from the intended receiver(s) indicating that a packet was successfully received. When the number of consecutive failure/successfully transmitted packets reach a threshold number (which, in some embodiments is different for as between unsuccessfully transmitted packets and successfully transmitted packets), the transmitter accordingly adjusts the transmission rate: decrease for failures, increase for successful transmitted packets.

Embodiment 600 begins with retrieving the current packet failure and packet success tallies associated with traffic flow N (block 605), where N identifies the specific traffic flow for a given transmitting technology. The packet of traffic flow N is transmitted (block 610) to the receiver, e.g., STA1. At decision block 615 it is determined whether the packet was successfully transmitted (i.e., whether the packet was successfully received by the receiver). Assuming the packet was not successfully received—at decision block 620 calculator 440 compares the value in tally register 490 with a predetermined failure threshold. If the value in tally 490 is not greater than the predetermined failure threshold, then counter 450 increments packet failure tally 490, and leaves packet success tally 480 unchanged (block 625). Embodiment 600 then returns to block 610 to retransmit the packet from traffic flow N at the same transmission rate (transmission rate unchanged).

If, however, the value in packet failure tally 490 is greater than the predetermined failure threshold (decision block 620), then the transmitter, e.g., AP, decreases the transmission rate (block 630), and counter 450 resets packet failure tally 490 and packet success tally 480 (block 635). Embodiment 600 then returns to block 610 to retransmit the packet from traffic flow N at the decreased transmission rate.

Alternatively, if it is determined at decision block 615 that the packet from traffic flow N was successfully transmitted—or more accurately, successfully received—at decision block 640 calculator 440 compares the value in packet success tally 480 with a predetermined success threshold. If the value in tally 480 is not greater than the predetermined success threshold, then counter 450 increments packet success tally 480, and leaves packet failure tally unchanged (block 645). Embodiment 600 then returns to block 610 to transmit the next packet from traffic flow N at the same transmission rate (transmission rate unchanged).

If, however, the value in the counter 480 is greater than the predetermined success threshold (decision block 640), then AP increases the transmission rate (block 650), and counter 450 resets packet failure tally 490 and packet success tally 480 (block 655). Embodiment 600 then returns to block 610 to transmit the next packet from traffic flow N at the increased transmission rate. It should be appreciated that, depending upon the particular embodiment, the transmitter may reset both the tallies, either tally or neither tally. At least some embodiments implementing a no-tally reset for one or both tallies, may increment the corresponding predetermined threshold value or may alternatively determine a difference between current tally value and previous tally value before comparing the relevant tally with the corresponding predetermined threshold.

It should be appreciated that in other embodiments, for example, nothing at all may occur as a result of the packet success tally 480 exceeding a predetermined success threshold; such embodiments may only address the scenarios when there is packet failure. Alternatively, in further embodiments, for example, nothing at all may occur as a result of the packet failure tally 490 exceeding a predetermined failure threshold; such embodiments may only address the scenarios when there is packet success.

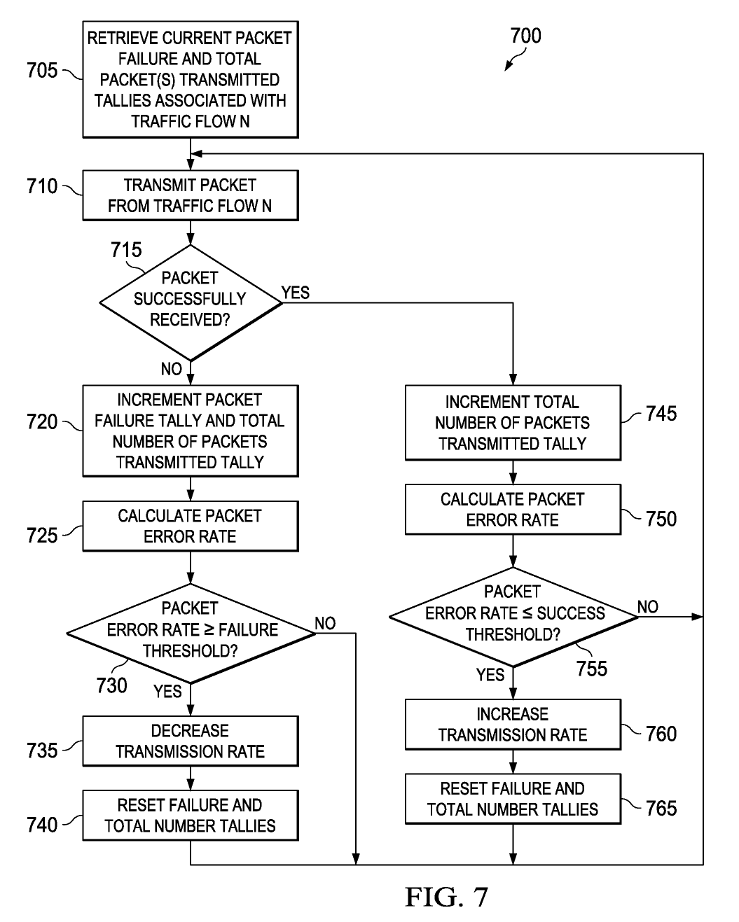

FIG. 7 illustrates another exemplary method for adapting transmission rate on a per flow basis, according to embodiments.

Embodiment 700 begins with retrieving the current packet failure and total packets transmitted tallies (490, 495) associated with traffic flow N (block 705), where N identifies the specific traffic flow for a given transmitting technology. The packet of traffic flow N is transmitted (block 710) to the receiver, e.g., STA1. At decision block 715 it is determined whether the packet was successfully transmitted (i.e., whether the packet was successfully received by the receiver). Embodiments determine whether a transmitted packet was successfully received by whether the transmitter receives an ACK or Block ACK (acknowledgements) from the intended receiver(s) indicating that a packet was successfully received.

Assuming the packet was not successfully received, counter 450 increments packet failure tally 490 and total number of packets transmitted tally 495 (block 720). Calculator 440 uses the results of tally 490 and total number of packets transmitted tally 495 to calculate the packet error rate (block 725). At decision block 730, calculator 440 compares the packet error rate with a predetermined failure threshold. If the packet error rate is less than the failure threshold, embodiment 700 proceeds to transmit (or retransmit, for some embodiments) a packet from traffic flow N (block 710). If, however the packet error rate is greater than or equal to the failure threshold, controller 420 decreases the transmission rate at which the next packet is to be transmitted (block 735), and counter 450 may reset failure tally 490 and total number tally 495 (block 740). Embodiment 700 then returns to block 710 to transmit/retransmit a packet from traffic flow N at the slower (lower) transmission rate.

If, at decision block 715, it is determined that the packet was successfully received, counter 450 increments total number of packets transmitted tally 495, and leaving packet failure tally 490 unchanged (block 745). Calculator 440 uses the results of tally 490 and total number of packets transmitted tally 495 to calculate the packet error rate (block 750). At decision block 755, calculator 440 compares the packet error rate with a predetermined success threshold. If the packet error rate is greater than the failure threshold, embodiment 700 proceeds to transmit a subsequent packet from traffic flow N (block 710). If, however the packet error rate is less than or equal to the success threshold, controller 420 increases the transmission rate at which the next packet is to be transmitted (block 760), and counter 450 may reset failure tally 490 and total number tally 495 (block 765). Embodiment 700 then returns to block 710 to transmit a subsequent packet from traffic flow N at the faster (higher) transmission rate. It should be appreciated that, depending upon the particular embodiment, the transmitter may reset both the tallies, either tally or neither tally. At least some embodiments implementing a no-tally reset for one or both tallies, may increment the corresponding predetermined threshold value or may alternatively determine a difference between current tally value and previous tally value before comparing the relevant tally with the corresponding predetermined threshold.

It should be appreciated that in other embodiments, for example, nothing at all may occur as a result of the packet success tally 480 exceeding a predetermined success threshold; such embodiments may only address the scenarios when there is packet failure. Alternatively, in further embodiments, for example, nothing at all may occur as a result of the packet failure tally 490 exceeding a predetermined failure threshold; such embodiments may only address the scenarios when there is packet success.

It should be appreciated that, depending upon the transmission rules among devices in a network, as well as whether (in some cases) there is a predetermined limit to the number of times a device will attempt to retransmit the same packet, the subsequent packet transmitted may be a retransmission of the original packet, a transmission of a variation of the original packet, transmission of a different packet, etc.

Just as the two predetermined thresholds (success and failure) may, in some embodiments, be different within a particular traffic flow, some embodiments may assign lower predetermined threshold numbers to traffic flows with larger packets for decreasing the transmission rate than the value of predetermined threshold numbers for traffic flows with smaller packets. Further, some embodiments may enable the transmitter to adjust the transmission rate itself downwards to a predetermined threshold before, for example, ceasing further transmission attempts for that traffic flow with that receiver. Moreover, some embodiments will limit the number of times retransmission of a packet is attempted (up to a predetermined threshold) before the transmitter stops retransmitting the packet to the particular receiver (i.e., the transmitter determines the message cannot reach the receiver for some reason).

Similarly, it should be appreciated that some embodiments may assign lower predetermined threshold numbers to traffic flows with smaller packets for increasing the transmission rate than the value of predetermined threshold numbers for traffic flows with larger packets. Further, some embodiments may enable the transmission rate itself to be adjusted upwards up to a predetermined threshold.

As an illustrative example, and not by way of limitation, assume a single transmitting device implementing present embodiments has a plurality of traffic flows—any of which may be active. Further assume traffic flow N₁ experiences ten consecutive transmission failures, traffic flow N₂ experiences five consecutive transmission failures, and traffic flow N₃ experiences no transmission failures. Traffic flow N₁ implements (as defined by the traffic flow/QoS requirements) large packet size for its transmissions. Traffic flow N₂ implements (again, as defined by the traffic flow/QoS requirements) small packet size for its transmissions. Traffic flow N₃ implements (as defined by the traffic flow/QoS requirements) large packet size for its transmissions. Further assume, for the sake of illustration and not by way of limitation, that traffic flow N₁ has a predetermined failure threshold of ten (10), traffic flow N₂ has a predetermined failure threshold of fifteen (15), and traffic flow N₃ has a predetermined failure threshold of five (5). As the number of failures for traffic flow N₁ has met or exceeded the predetermined failure threshold for that specific traffic flow, embodiments of the transmitter (assume the AP for this example) reduce the transmission rate for only traffic flow N₁ in an effort to achieve a successful transmission; the transmission rate for traffic flows N₂ and N₃ remains unchanged. Thus, the AP will continue to transmit packets of traffic flow N₂ at the unchanged transmission rate associated with traffic flow N₂, and will continue to transmit packets of traffic flow N₃ at the transmission rate associated with traffic flow N₃. If, however, traffic flow N₂ continues to have failures and finally meets or exceeds the predetermined failure threshold in this example of fifteen (15) consecutive packet failures, then the AP begins to reduce the transmission rate in the traffic flow N₂ in an effort to achieve a successful transmission in that traffic flow. Meanwhile, the AP continues to transmit packets according to the transmission rate associated with traffic flow N₃. Assuming that the packets continue to be successfully received, in at least some embodiments, the AP will increase the transmission rate at which it transmits packets for the traffic flow N₃, even while the transmission rate for traffic flow N₂ remains unchanged and the transmission rate for traffic flow N₁ has been decreased. Assuming that the packets of traffic flow N₁ are finally successfully received at the decreased transmission rate, if enough consecutive packets (predetermined success threshold) are successfully received at the decreased transmission rate, the AP—in at least some embodiments—will increase the transmission rate for packets in traffic flow N₁. As is clear, whether the rates increase, decrease or remain the same is determined and managed on a flow-by-flow basis without adversely affecting the other traffic flows of a transmitter.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communications system, comprising:
at least one receiver; and
a transmitter able to control transmission to the at least one receiver of a packet among a plurality of traffic flows, each traffic flow having its own transmission rate adaptation mechanism.

2. The communications system of claim 1, wherein the transmitter adapts a transmission rate of at least one of the traffic flows with its own rate adaptation mechanism to an at least one intended receiver based on the number of packet transmission rate failures.

3. The communications system of claim 2, wherein the transmitter adapts the transmission rate by reducing the transmission rate.

4. The communications system of claim 2, wherein the transmitter compares the number of packet transmission rate failures with a predetermined threshold to determine whether to adapt the transmission rate.

5. The communications system of claim 1, wherein at least one of the traffic flows with its own rate adaptation mechanism adapts a transmission rate to an at least one intended receiver based on the number of packet transmission rate successes.

6. The communications system of claim 5, wherein the transmitter adapts the transmission rate by increasing the transmission rate.

7. The communications system of claim 5, wherein the transmitter compares the number of packet transmission rate successes with a predetermined threshold to determine whether to adapt the transmission rate.

8. The communications system of claim 1, wherein the transmitter adapts a transmission rate of at least one of the traffic flows with its own rate adaptation mechanism to an at least one intended receiver based on a packet error rate.

9. The communications system of claim 1, wherein the transmitter adapts a transmission rate of at least one of the traffic flows with its own rate adaptation mechanism to an at least one intended receiver based on at least one parameter, the parameter selected from the group of: signal-to-noise ratio of the transmission channel, packet error rate, bit error rate, level of power used for transmission, error control parameters, number of packet transmission failures, number of packet transmission successes, packet size, and a communication channel parameter.

10. A method for communicating, comprising:
determining, by a transmitter able to control transmission of a packet among a plurality of traffic flows each having its own transmission rate adaptation mechanism, a parameter value; and
depending upon the parameter value, adapting the transmission rate of at least one traffic flow.

11. The method of claim 10, wherein the adapting further comprises comparing the determined parameter value with a threshold value to determine whether to adapt the transmission rate of the corresponding traffic flow.

12. The method of claim 10, wherein the determining a parameter value comprises determining a number of packet transmission rate failures.

13. The method of claim 12, wherein the adapting further comprises reducing the transmission rate.

14. The method of claim 10, wherein the determining a parameter value comprises determined a number of packet transmission rate successes.

15. The method of claim 14, wherein the adapting further comprises increasing the transmission rate.

16. The method of claim 10, wherein the determining a parameter value comprises determining a packet error rate.

17. The communications system of claim 10, wherein the step of adapting further comprises adapting a transmission rate of at least one of the traffic flows with its own rate adaptation mechanism to an at least one intended receiver based on at least one parameter, the parameter selected from the group of: signal-to-noise ratio of the transmission channel, packet error rate, bit error rate, level of power used for transmission, error control parameters, number of packet transmission failures, number of packet transmission successes, packet size, and a communication channel parameter.

18. A communications device, comprising:
a transmitter able to control transmission of a packet among a plurality of traffic flows, each traffic flow having its own transmission rate adaptation mechanism.

19. The communications device of claim 18, wherein the transmitter adapts a transmission rate of at least one of the traffic flows with its own rate adaptation mechanism to an at least one intended receiver based on the number of packet transmission rate failures.

20. The communications device of claim 18, wherein the transmitter adapts a transmission rate of at least one of the traffic flows with its own rate adaptation mechanism to an at least one intended receiver based on a determined parameter value.

21. The communications device of claim 18, wherein the transmitter adapts a transmission rate of at least one of the traffic flows with its own rate adaptation mechanism to an at least one intended receiver based on at least one parameter, the parameter selected from the group of: signal-to-noise ratio of the transmission channel, packet error rate, bit error rate, level of power used for transmission, error control parameters, number of packet transmission failures, number of packet transmission successes, packet size, and a communication channel parameter.

22. The communication device of claim 18, wherein the transmitter compares a determined parameter value with a threshold value to determine whether to adapt the transmission rate of a corresponding traffic flow.

23. The communications device of claim 18, wherein the transmitter adapts the transmission rate by reducing the transmission rate.

24. The communications device of claim 18, wherein the transmitter adapts the transmission rate by increasing the transmission rate.
